(19) United States
(12) Patent Application Publication
(10) Pub. No.: US 2014/0279659 A1
(43) Pub. Date: Sep. 18, 2014

(54) Graphical Fulfillment Methods and Systems

(71) Applicant: Gordon E. Seay, San Diego, CA (US)

(72) Inventor: Gordon E. Seay, San Diego, CA (US)

(21) Appl. No.: 13/841,533

(22) Filed: Mar. 15, 2013

(51) Int. Cl. G06Q 10/08

(52) U.S. Cl. CPC G06Q 10/083
USPC 705/337

(57) ABSTRACT

Graphical logistics management methods including providing a data storage and displaying a pictorial quantity graphic depicting an allocated quantity of an ordered item allocated to one or more shipping containers associated with an order. The data storage store an order item record associated with the order and the order item record includes an order quantity field. The order quantity field includes quantity data denoting an ordered quantity of an ordered item. Displaying the pictorial quantity graphic occurs on a display unit of a computer configured to access the order item record. In some examples, the method includes displaying a container display pictorially depicting a shipping container and dynamically updating the container display. In some examples, the method includes adjusting container parameters based on calculations associated with an order.

### BACKGROUND

The present disclosure relates generally to electronic fulfillment systems. In particular, electronic fulfillment systems that display graphical elements associated with product orders are described.

Known fulfillment systems often fail to provide fulfillment staff with sufficient visual aids to efficiently and conveniently fulfill orders. For example, many fulfillment systems, including many electronic and/or computer based systems, simply represent ordered items and their respective fulfillment status in static alphanumeric text. As a result, such fulfillment systems are often difficult to read and using them leads to errors when fulfilling customer orders.

For example, conventional fulfillment systems increase the risk that fulfillment staff members will fulfill orders inefficiently and add costs to a business. Current fulfillment systems are prone to cause staff to ship the wrong quantity of an item, ship the wrong item, or waste time attempting to locate an item within a warehouse. Further, existing fulfillment systems cause staff to consume an inefficient amount of time preparing the correct items for shipment or choosing a proper container size for the items in an order. Moreover, known fulfillment systems are prone to lead staff to choose an inefficiently expensive shipping method for the container or require staff to check inventory within a separate or manual system.

In addition, conventional fulfillment systems inadequately capitalize on the processing power and networking capabilities of computers to automatically consider various fulfillment configurations to efficiently and economically pack ordered items into containers. For example, many conventional fulfillment systems require fulfillment staff to manually allocate ordered items into containers when fulfilling a customer order. Because they often lack a computer's ability to analyze efficient packing configurations, fulfillment staff members are often ill-equipped to determine efficient container packing configurations. Further, fulfillment staff members preparing shipments often have little understanding of current shipping rates associated with the current order and are likewise ill-equipped to determine the most economical container packing configurations.

Thus, there exists a need for graphical fulfillment systems that improve upon and advance the design of known fulfillment systems. Examples of new and useful graphical fulfillment systems relevant to the needs existing in the field are discussed below.

### SUMMARY

The present disclosure is directed to graphical logistics management methods including providing a data storage and displaying a pictorial quantity graphic depicting an allocated quantity of an ordered item allocated to one or more shipping containers associated with an order. The data storage stores an order item record associated with the order and the order item record includes an order quantity field. The order quantity field includes quantity data denoting an ordered quantity of an ordered item. Displaying the pictorial quantity graphic occurs on a display unit of a computer configured to access the order item record. In some examples, the method includes displaying a container display pictorially depicting a shipping container and dynamically updating the container display. In some examples, the method includes adjusting container parameters based on calculations associated with an order.

### BRIEF DESCRIPTION OF THE DRAWINGS

FIG. 1 shows a schematic view of an example of a programmable computing device.

FIG. 2 shows a schematic view of an example of a mobile electronic device.

FIG. 3 shows a diagrammatic view of a graphical fulfillment server, a client computer, and a carrier server.

FIG. 4 is a flow diagram of a first example of a graphical fulfillment method.

FIG. 5 is a screenshot of a first example of a graphical fulfillment interface produced by methods described herein.

FIG. 6 is a screenshot of a second example of a graphical fulfillment interface produced by methods described herein.

FIG. 7 is a screenshot of a third example of a graphical fulfillment interface produced by methods described herein.

FIG. 8 is a screenshot of a fourth example of a graphical fulfillment interface produced by methods described herein.

### DETAILED DESCRIPTION

The disclosed methods and systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various methods and systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

Various disclosed examples may be implemented using electronic circuitry configured to perform one or more functions. For example, with some embodiments of the invention, the disclosed examples may be implemented using one or more application-specific integrated circuits (ASICs). More typically, however, components of various examples of the invention will be implemented using a programmable computing device executing firmware or software instructions, or by some combination of purpose-specific electronic circuitry and firmware or software instructions executing on a programmable computing device.

Accordingly, FIG. 1 shows one illustrative example of a computer, computer 101, that can be used to implement various embodiments of the invention. Computer 101 may be incorporated within a variety of consumer electronic devices, such as personal media players, cellular phones, smart phones, personal data assistants, global positioning system devices, and the like.

As seen in this figure, computer 101 has a computing unit 103. Computing unit 103 typically includes a processing unit 105 and a system memory 107. Processing unit 105 may be any type of processing device for executing software instructions, but will conventionally be a microprocessor device. System memory 107 may include both a read-only memory (ROM) 109 and a random access memory (RAM) 111. As will be appreciated by those of ordinary skill in the art, both read-only memory (ROM) 109 and random access memory (RAM) 111 may store software instructions to be executed by processing unit 105.

Processing unit 105 and system memory 107 are connected, either directly or indirectly, through a bus 113 or alternate communication structure to one or more peripheral devices. For example, processing unit 105 or system memory 107 may be directly or indirectly connected to additional memory storage, such as a hard disk drive 117, a removable optical disk drive 119, a removable magnetic disk drive 125, and a flash memory card 127. Processing unit 105 and system memory 107 also may be directly or indirectly connected to one or more input devices 121 and one or more output devices 123. Input devices 121 may include, for example, a keyboard, touch screen, a remote control pad, a pointing device (such as a mouse, touchpad, stylus, trackball, or joystick), a scanner, a camera or a microphone. Output devices 123 may include, for example, a monitor display, an integrated display, television, printer, stereo, or speakers.

Still further, computing unit 103 will be directly or indirectly connected to one or more network interfaces 115 for communicating with a network. This type of network interface 115, also sometimes referred to as a network adapter or network interface card (NIC), translates data and control signals from computing unit 103 into network messages according to one or more communication protocols, such as the Transmission Control Protocol (TCP), the Internet Protocol (IP), and the User Datagram Protocol (UDP). These protocols are well known in the art, and thus will not be discussed here in more detail. An interface 115 may employ any suitable connection agent for connecting to a network, including, for example, a wireless transceiver, a power line adapter, a modem, or an Ethernet connection.

It should be appreciated that, in addition to the input, output and storage peripheral devices specifically listed above, the computing device may be connected to a variety of other peripheral devices, including some that may perform input, output and storage functions, or some combination thereof. For example, the computer 101 may be connected to a digital music player, such as an IPOD® brand digital music player, or iOS-based or Android based smartphone. As known in the art, this type of digital music player can serve as both an output device for a computer (e.g., outputting music from a sound file or pictures from an image file) and a storage device.

In addition to a digital music player, computer 101 may be connected to or otherwise include one or more other peripheral devices, such as a telephone. The telephone may be, for example, a wireless “smart phone,” such as those featuring the Android or iOS operating systems. As known in the art, this type of telephone communicates through a wireless network using radio frequency transmissions. In addition to simple communication functionality, a “smart phone” may also provide a user with one or more data management functions, such as sending, receiving and viewing electronic messages (e.g., electronic mail messages, SMS text messages, etc.), recording or playing back sound files, recording or playing back image files (e.g., still picture or moving video image files), viewing and editing files with text (e.g., Microsoft Word or Excel files, or Adobe Acrobat files), etc. Because of the data management capability of this type of telephone, a user may connect the telephone with computer 101 so that maintained data may be synchronized.

Of course, still other peripheral devices may be included with or otherwise connected to a computer 101 of the type illustrated in FIG. 1, as is well known in the art. In some cases, a peripheral device may be permanently or semi-permanently connected to computing unit 103. For example, with many computers, computing unit 103, hard disk drive 117, removable optical disk drive 119 and a display are semi-permanently encased in a single housing.

Still other peripheral devices may be removably connected to computer 101, however. Computer 101 may include, for example, one or more communication ports through which a peripheral device can be connected to computing unit 103 (either directly or indirectly through bus 113). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computer 101 may include a wireless data “port,” such as a Bluetooth® interface, a Wi-Fi interface, an infrared data port, or the like.

It should be appreciated that a computing device employed according various examples of the invention may include more components than computer 101 illustrated in FIG. 1, fewer components than computer 101, or a different combination of components than computer 101. Some implementations of the invention, for example, may employ one or more computing devices that are intended to have a very specific functionality, such as a digital music player or server computer. These computing devices may thus omit unnecessary peripherals, such as the network interface 115, removable optical disk drive 119, printers, scanners, external hard drives, etc. Some implementations of the invention may alternately or additionally employ computing devices that are intended to be capable of a wide variety of functions, such as a desktop or laptop personal computer. These computing devices may have any combination of peripheral devices or additional components as desired.

In many examples, computers may define mobile electronic devices, such as smartphones, tablet computers, or portable music players, often operating the iOS, Symbian, Windows-based (including Windows Mobile and Windows 8), or Android operating systems.

With reference to FIG. 2, an exemplary mobile device, mobile device 200, may include a processor unit 203 (e.g., CPU) configured to execute instructions and to carry out operations associated with the mobile device. For example, using instructions retrieved for example from memory, the controller may control the reception and manipulation of input and output data between components of the mobile device. The controller can be implemented on a single chip, multiple chips or multiple electrical components. For example, various architectures can be used for the controller, including dedicated or embedded processor, single purpose processor, controller, ASIC, etc. By way of example, the controller may include microprocessors, DSP, A/D converters, D/A converters, compression, decompression, etc.

In most cases, the controller together with an operating system operates to execute computer code and produce and use data. The operating system may correspond to well-known operating systems such iOS, Symbian, Windows-based (including Windows Mobile and Windows 8), or Android operating systems, or alternatively to special purpose operating system, such as those used for limited purpose appliance-type devices. The operating system, other computer code and data may reside within a system memory 207 that is operatively coupled to the controller. System memory 207 generally provides a place to store computer code and data that are used by the mobile device. By way of example, system memory 207 may include read-only memory (ROM) 209, random-access memory (RAM) 211. Further, system memory 207 may retrieve data from storage units 294, which may include a hard disk drive, flash memory, etc. In conjunction with system memory 207, storage units 294 may include a removable storage device such as an optical disc player that receives and plays DVDs, or card slots for receiving storage media such as memory cards (or memory sticks).

Mobile device 200 also includes input devices 221 that are operatively coupled to processor unit 203. Input devices 221 are configured to transfer data from the outside world into mobile device 200. As shown, input devices 221 may correspond to both data entry mechanisms and data capture mechanisms. In particular, input devices 221 may include touch sensing devices 232 such as touch screens, touch pads and touch sensing surfaces, mechanical actuators 234 such as button or wheels or hold switches, motion sensing devices 236 such as accelerometers, location detecting devices 238 such as global positioning satellite receivers, WiFi based location detection functionality, or cellular radio based location detection functionality, force sensing devices such as force sensitive displays and housings, image sensors, and microphones. Input devices 221 may also include a clickable display actuator.

Mobile device 200 also includes various output devices 223 that are operatively coupled to processor unit 203. Output devices 233 are configured to transfer data from mobile device 200 to the outside world. Output devices 233 may include a display unit 292 such as a LCD, speakers or jacks, audio/tactile feedback devices, light indicators, and the like.

Mobile device 200 also includes various communication devices 246 that are operatively coupled to the controller. Communication devices 246 may, for example, include both an I/O connection 247 that may be wired or wirelessly connected to selected devices such as through IR, USB, or Firewire protocols, a global positioning satellite receiver 248, and a radio receiver 250 which may be configured to communicate over wireless phone and data connections. Communication devices 246 may also include a network interface 252 configured to communicate with a computer network through various means which may include wireless connectivity to a local wireless network, a wireless data connection to a cellular data network, a wired connection to a local or wide area computer network, or other suitable means for transmitting data over a computer network.

Mobile device 200 also includes a battery 254 and possibly a charging system. Battery 254 may be charged through a transformer and power cord or through a host device or through a docking station. In case of the docking station, the charging may be transmitted through electrical ports or possibly through an inductance charging means that does not require a physical electrical connection to be made.

The various aspects, features, embodiments or implementations of the invention described above can be used alone or in various combinations. The methods of this invention can be implemented by software, hardware or a combination of hardware and software. The invention can also be embodied as computer readable code on a computer readable medium. The computer readable medium is any data storage device that can store data which can thereafter be read by a computer system, including both transfer and non-transfer devices as defined above. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

With reference to FIGS. 3-8, various examples of graphical logistics fulfillment methods and systems are discussed. The disclosed methods and systems may be used by businesses to provide fulfillment staff members easy to read, graphical shipping information that can be reviewed while fulfilling customers' orders. Further, the disclosed methods and systems are may be connected via a data network to servers hosting data associated with carriers' rates, scheduling, and other logistics information. Accordingly, the systems and methods described herein may dynamically update during fulfillment in response to current and changing data. As a result, the disclosed methods and systems provide fulfillment staff with a near real-time visual guide that reflects the current progress in fulfilling an order.

FIGS. 5-8 illustrate examples of graphical fulfillment interfaces displayed by examples of graphical fulfillment systems according to the present disclosure, and they may be referred to throughout to help understanding of the underlying systems and methods.

With reference to FIG. 3, some examples of the disclosed methods may implement a graphical fulfillment server that hosts data associated with product inventories, products, containers, orders, customer information, and other data relevant to fulfilling shipments of customer orders. FIG. 3 provides a schematic illustrating a data organizational scheme hosted by an example graphical fulfillment server, graphical fulfillment server 300.

Graphical fulfillment server 300 may be any type of network-connected computing device, such as computer 101 and/or mobile electronic device 200. In some examples, graphical fulfillment servers may define clusters of computing devices configured to cooperate to deliver content to client computers. In some example, graphical fulfillment server 300 may host one or more hosted applications, cloud services, or other models that provide software as a service. In some examples, graphical fulfillment server 300 may host one or more hosted applications on a network connected data server and include processor executable instructions associated with hosted applications for displaying user-manipulable graphical fulfillment interfaces on web browsers on client computers. The client computers may access and operate the hosted applications, for example, in a shipping center or other location where a fulfillment staff is fulfilling orders stored on graphical fulfillment server 300. Graphical fulfillment server 300 may, for example, transfer browser executable code for displaying the graphical fulfillment interface on client computers over a computer network, and the client computers may translate the browser executable code in a browser to display the associated graphical fulfillment interface.

In some examples, application servers may define multiple clustered computing devices rather than a single computing device. For example, application servers may define web server clusters configured to cooperate to serve web content to client computers.

In some examples, state data is stored on or within remotely hosted state servers, locally hosted state servers, application servers, database servers, hidden form fields, querystrings, cookies, or some combination thereof.

In some examples, graphical fulfillment servers may additionally include customer data, which may include customer names, address information, billing information, and other customer information used in the shipping process. The customer data may be used, for example, in printing address labels that may be affixed to containers for shipping. FIG. 3 illustrates an example including a customer data field 399 configured to store such customer data.

As FIG. 3 shows, graphical fulfillment server 300 includes a data storage that includes inventory data 310, item data 320, container data 340, and order data 350. In some examples, some or all of the data stored by graphical fulfillment server 300 is stored in one or more relational databases. Graphical fulfillment interfaces displayed on client computers and connected to graphical fulfillment servers may access and manipulate these data. As a result, graphical fulfillment interfaces may serve as front ends allowing users to access and manipulate data stored on graphical fulfillment servers.

In some examples, graphical fulfillment servers may additionally include customer data 399, which may include customer names, address information, billing information, and other customer information used in the shipping process. The customer data may be used, for example, in printing address labels that may be affixed to containers for shipping. In some examples, various orders or order item records may be associated with particular customer records stored in the customer data. In some examples, these orders and order items may be combined with other pending orders associated with the user to efficiently and economically fulfill the customer's orders. In some examples, the customer data may include the customer's location, which may be used to print shipping labels or calculate estimated shipping costs.

Inventory data 310 stores data relating to each of the items. For example, inventory data 310 may include records associated with each of the products offered for shipment by the entity hosting graphical fulfillment server 300. Inventory data may further include the quantities of each product currently available for shipment, local inventories associated with the amount of product available at each of an associated entity's one or more local warehouses, and the warehouse locations denoting the particular locations within particular warehouses, such as a particular row and shelf, where the product can be found when fulfilling orders. In some examples, inventory data may include photographs or other graphical depictions of one or more of the items in the inventory.

Item data 320 includes data associated with offered items. As FIG. 3 illustrates, item data 320 includes a plurality of item records 322, each associated with one of the offered items. As FIG. 3 shows, each item record 322 includes a parameter data field 324 containing item parameter data. Each item record 322 includes display names, unique item identifiers such as stock-keeping units, photographs or other graphical depictions of the associated product, or other information identifying or describing the product.

Item parameter data of Parameter data field 324 denotes the physical characteristics of the associated item that are relevant to packing the item. For example, the item parameter data of parameter data field 324 may define suggested dimensions associated with packing an individual unit of the ordered item. In some examples, the suggested dimensions define the physical dimensions of the associated item, including the item's length, width, and height. In other examples, however, suggested dimensions may differ from the associated items physical dimensions. For example, the suggested dimensions may exceed or underestimate the physical dimensions of items to compensate for packing materials or other considerations that may require more or less than the physical dimensions of the product.

In some examples, parameter data field 324 may include a suggested weight capacity associated with packing an individual unit of the ordered item. The suggested weight capacity indicates the weight to consider when calculating an item's contribution to the total load of items in a container. The suggested weight capacity is, in some examples, the weight of the associated item. In other examples, however, suggested weight capacities vary from an item's actual weight. For example, some items may define shapes and densities that cause them to contribute to the load to a greater or lesser extent than their weight would indicate.

Container data 340 includes data associated with each of the types of shipping containers available to fulfill customers' orders. As FIG. 3 shows, container data 340 includes a plurality of container records 342, each associated with a container available to be used to pack items when fulfilling orders.

As FIG. 3 shows, each container record 342 includes a parameter data field 344 containing container parameter data denoting the container parameters associated with the physical characteristics of the associated type of shipping container and its capacity for packing ordered items. In some examples, the container parameter data of parameter data field 344 define container dimensions and a container weight capacity for the associated shipping container. The container dimensions denote the physical dimensions of the associated container type that may be used to pack items, including the length, width, and height of the container. The container weight capacity denotes the amount of weight that may safely be packed into the associated container type. In some examples, the container record may additionally or alternatively include container manufacturer data denoting the manufacturer of the associated container, model data denoting the model or product number of the associated container, and container graphical depiction data including a photo or other graphical depiction of the container that may be displayed, for example, on graphical fulfillment interfaces.

Order data 350 includes data associated with one or more orders that may be fulfilled using the graphical fulfillment system. As FIG. 3 illustrates, order data 350 includes one or more order records 352, each associated with a customer's order. Customer orders, for example, may have been made on a storefront linked to the graphical fulfillment system, an invoice application, a related sales application, a retail location, or other means of taking orders for shipped items, including those configured to receive orders over a computer network.

As FIG. 3 shows, each order record 352 includes one or more order item records 354, with each order item record 354 associated with a type of item ordered in the associated order. Each order item record beyond the first may, for the purposes of this disclosure, be referred to as an additional order item record, and associated data and related elements may include an additional modifier to indicate its relationship to the additional order items. As FIG. 3 shows, each order item record 354 is associated with an item record 322, from which the order item record 354 can access the data associated with that type of item, such as inventory and parameter data.

As FIG. 3 illustrates, each order item record 354 includes ordered quantity field 356 and an allocated quantity field 358. The ordered quantity field 356 includes quantity data that denotes the quantity of the ordered item that was ordered in the corresponding order. For example, FIGS. 5-8 illustrate an example of a graphical fulfillment interface associated with an order. The order depicted in FIGS. 5-8 is for 3 6″ SCSI Cables, 5 Ergo Keyboards, 3 Rollerball Mice, and 2 Seastar 1 TB Hard Drives.

As FIG. 5 shows, each ordered quantity includes all ordered items of a particular type. For example, each displayed quantity is associated with each of the items having the same SKU.

As FIG. 3 shows, each order record 352 includes one or more order container records 360. Each container record beyond the first may, for the purposes of this disclosure, be referred to as an additional container record, and associated data and related elements may include an additional modifier to indicate its relationship to the additional order items. Each order container record 360 is associated with a container to which ordered items associated with the order may be allocated. As FIG. 3 shows, each order container record 360 is associated with a container record 342, which corresponds to a type of shipping container used to fulfill the order. Order container record 360 being linked to container record 342 allows order record 352 to access the container data associated with the type of container associated with the order.

As FIG. 3 shows, each order record 352 includes carrier data 370 denoting the carrier or carriers whom the fulfillment staff plans to employ in fulfilling the order. In examples where multiple carriers are being used to fulfill an order, the carrier data may denote which containers have been allocated to each carrier.

As FIG. 3 illustrates, graphical fulfillment server 300 is configured to communicate with a client computer 380 over a computer network. In some examples, client computer 380 includes a display unit located in a shipping facility. In such examples, client computer 380 is configured to display graphical fulfillment interfaces generated by graphical fulfillment server 300 to provide fulfillment staff with a visual guide to assist in packing customers' orders.

Client computers may define a wide variety of computing devices, such as computer 101 and/or mobile electronic device 200 described above. In particular, this disclosure notes that client computers may define desktop computers, laptop computers, smartphones, personal data assistants, tablets, or other touchscreen devices. The simplicity of touch interface provided by touchscreen enabled devices may provide particular benefits to fulfillment staff.

As FIG. 3 shows, graphical fulfillment server 300 includes computer executable code configured to communicate with a software interface 392 hosted by a shipping carrier server 390 to receive data from an associated carrier that may be relevant to fulfillment. In some examples, software interface 392 defines as an exposed API that allows applications, such as those used in disclosed graphical fulfillment methods and systems, to electronically communicate with servers hosted by the carrier. In some examples, the computer executable code operated by graphical fulfillment server 300 to access data from software interface 392 may define an API, library, include, or other code operatively paired with software interface 392 to allow communication between graphical fulfillment server 300 and shipping carrier server 390.

Shipping carrier server 390 includes shipping carrier data denoting information associated with the carrier, such as shipping rates charged by the shipping carrier, scheduling data, and other logistical information. Graphical fulfillment servers may use the data received from shipping carrier server 390 to make graphical fulfillment interfaces responsive to information received from carriers.

As FIG. 3 shows, shipping carrier server 390 hosts pricing data 391 defining the current shipping rates charged by the shipping carrier for shipping parcels. In some examples, the pricing data 391 may provide pricing that is based on the weight and dimensions of parcels and the destination and arrival locations.

In some examples, software interface 392 may include software that allows graphical fulfillment server 300 or client computer 380 to generate and print shipping labels appropriate for shipping with the associated carrier. In some examples, software interface 392 allows graphical fulfillment server 300 or client computer 380 to send receiving shipping payments to the carrier, and printed labels may reflect that shipping payment has been received.

In some examples, software interface 392 may allow graphical fulfillment server 300 or client computer 380 to schedule pickup appointments with the carrier.

With reference to FIG. 4, an example of a graphical fulfillment method, method 400 will now be described. As FIG. 4 shows, method 400 includes providing a graphical fulfillment server at step 405, displaying, on a display unit of a client computer, a graphical fulfillment interface at step 410, entering allocation data as items are packed into one or more selected containers at step 413, updating data on the graphical fulfillment server at step 415, updating the dynamically updating elements of the graphical fulfillment interface at step 420, adjusting one or more of the shipping containers to a closed configuration at step 445, printing a shipping label in response to user selection of a print label element at step 450, and shipping one or more containers associated with an order at step 455.

A graphical fulfillment server is provided at step 405. The graphical fulfillment server may be, for example, substantially similar to graphical fulfillment server 300. In some examples, the graphical fulfillment server is accessible by client computers over a computer network. For example, fulfillment staff may use a display unit of a client computer a graphical fulfillment interface in a shipping facility, the client computer being connected to the graphical fulfillment server. In some examples, the client computer and graphical fulfillment server may operate on the same computer. Though the client computer and graphical fulfillment server may be organized with a client/server architecture in some examples, a single software application operating on a single client computer may allow the client computer to serve as the functional equivalent to both the graphical fulfillment server and the client computer.

A graphical fulfillment interface is displayed on a display unit of a client computer at step 410. Displaying the graphical fulfillment interface includes displaying order information about each ordered item associated with a customer order, displaying one or more allocated quantity displays, displaying one or more dynamically updating container displays, displaying one or more user-selectable allocation adjustment controls, displaying user-selectable bulk allocation controls, displaying container controls associated with one or more containers associated with the order, and displaying a dynamically updating carrier selection element. Graphical fulfillment interfaces provide easy to read visual guides that fulfillment staff may review when fulfilling customers' orders. FIGS. 5-8 illustrate various configurations of an example of a graphical fulfillment interface, graphical fulfillment interface 501, that may be produced while performing the disclosed graphical fulfillment methods.

The graphical fulfillment interface includes a plurality of dynamically updating, graphical elements that are configured to update to reflect the current fulfillment status of the order. These dynamically updating graphical elements allow fulfillment staff members to persistently update and review their progress in fulfilling a customer's order.

As FIGS. 5-8 show, information about each ordered item associated with a customer order is displayed at step 410. As FIG. 5 illustrates, graphical fulfillment interface 501 includes, for each displayed order item, a display name 503, a unique item identification code 505, an ordered quantity display 507, and an available quantity display 508. Each of these informational displays may correspond to, for example, data stored in an item record, order item record, or inventory data on the graphical fulfillment server. Further, additional or alternative displays showing other data stored on graphical fulfillment servers, such as local inventories, warehouse locations, and product graphics, may be displayed on some graphical fulfillment interface examples. As FIG. 5 shows, each ordered quantity display 507 displays the quantity of the associated item ordered in the corresponding order, which may be associated with an ordered quantity, stored in an order item record, stored on the graphical fulfillment server.

Further, additional or alternative displays showing other data stored on graphical fulfillment servers, such as local inventories, warehouse locations, and product graphics, may be displayed on some graphical fulfillment interface examples. FIG. 7, for example, illustrates an item dialog 599 that displays a photographic depiction of the item 591, a warehouse location 592, and local inventory display 593 displaying a local inventory associated with the item.

In some examples, graphical fulfillment server 300 may check inventory data, including local inventories, to check product availabilities prior to displaying the ordered items on graphical fulfillment interface 501. In some examples, graphical fulfillment interface 501 may inform a user when the inventory indicates an insufficient stock to fulfill the order, either locally or in the entity's total inventory.

As FIGS. 5-8 show, one or more dynamically updating allocated quantity displays 512 associated with each ordered item are displayed on graphical fulfillment interface 501. As FIG. 5 shows, each allocated quantity display includes a dynamically updating pictorial quantity graphic and a text element. As FIGS. 5-8 show, each allocated quantity display 512 depicts an allocated quantity of the ordered item, stored in the order quantity field in the associated order item record.

As FIG. 7 illustrates, graphical fulfillment interface 501 may include a combine order element 598. A user may select the combine order element to combine the active order with other pending orders received from the same customer. Selecting combine order element, for example, may display a list of other orders or other ordered items associated with the same customer as the current order. This may allow users to pack orders going to the same customer together, which may allow the customer's products to be delivered more efficiently or economically.

Although some graphical fulfillment interfaces include such a manual combine order element, some graphical fulfillment servers may automatically combine orders pending with the same customer. For example, this disclosure discloses several methodologies and considerations that may be taken into account when automatically allocating items to containers associated with an order. In such examples, items from other pending orders associated with the same customer may be automatically allocated to the active container or other containers associated with the current order.

In some examples, the graphical fulfillment server may automatically associate with the current order items associated with other pending orders from the same customer. In such examples, they may be listed on the graphical fulfillment interface alongside the other “Items to Ship.”

Each allocated quantity display 512 is configured to adjust in response to the fulfillment status and/or allocated quantity of associated item being adjusted. The fulfillment status associated with each ordered item may be based on a fulfilled quantity associated with the ordered item. The fulfilled quantity may be calculated, for example, by subtracting the allocated quantity of the ordered item from the ordered quantity. The allocated quantity may include, in some examples, the quantity of the ordered item allocated to all of the containers associated with an order. An item's fulfillment status may be changed, for example, by adjusting the allocated quantity of the item by selecting an allocated item element 510 associated with the corresponding item.

FIGS. 5, 6, and 8 illustrate example allocated quantity display 512 associated with the second item displayed in FIG. 5, ‘ERGO KEYBOARD,’ indicates that all five ordered items are currently packed in one of the containers associated with the order. In FIG. 8, however, none of the five items have been packed, while in FIG. 6, only one of the five items has been packed.

The second item's corresponding pictorial quantity graphic 512 may, for example, be adjusted, in each of these cases, to reflect each of the items' fulfillment statuses. For example, the allocated quantity display 512 may be configured, in each case, to incorporate a fulfillment status color to reflect the item's current fulfillment status. For example, the allocated quantity display 512 associated with the second item may incorporate a green color in FIG. 5 to indicate that all of the ordered quantity is presently allocated, an orange color in FIG. 6 to indicate that at least one, but fewer than all, of the ordered quantity is presently allocated, and a red color in FIG. 8 to indicate that none of the ordered quantity is presently allocated. Each of these colors may be varied in actual implementation. Coloring the data may allow for quicker representation of packing status to fulfillment staff. Coloring the data may also allow for easier distant viewing of status.

As FIG. 6 illustrates, some orders may have already been partially packed and/or shipped, and active container display 520 may display a depiction of the container as closed as a result. In some examples, the fulfillment status of each ordered item will reflect the items packed in these closed containers and the items allocated to the closed container will be counted toward the allocated quantity of the associated item.

As FIG. 5-8 illustrate, one or more dynamically updating container displays are displayed on graphical fulfillment interface 501. In some examples, dynamically updating container displays are displayed for each order container record associated with an order, thus producing a container display for every shipping container either used or planned to be used to fulfill a customer order.

FIG. 5, for example, displays two examples of container displays, active container display 520 and inactive container display 535. As FIG. 5 shows, each container defines a visual appearance configured to reflect the items currently allocated to the shipping container. As FIG. 5 shows, active container display 520 includes a container parameter display displaying parameter data associated with the container, including dimensions defined by the container parameter data associated with the corresponding type of shipping container. The container parameter display may give a more precise reading of containers' dimensions than a pictorial representation.

As FIG. 5 shows, active container display 520 displays a container overlay 522 depicting the used capacity that includes data reflecting the current items allocated to the associated container. For example, container overlay 522 includes an allocated items display 524 depicting the amount of items currently allocated to the associated shipping container, a container weight display 526 depicting the weight of the container with each of the allocated items packed, a used capacity display 527 depicting the volume of the associated container currently used by items allocated to that container, and an estimated cost display 528 depicting the estimated cost of shipping the container with the carrier associated with the order.

The displayed estimated cost may be calculated based on pricing data received from a parcel carrier server. The graphical fulfillment server generating estimated cost display 528 may, for example, receive the pricing data by communicating with a shipping carrier server implementing an exposed software API, such as shipping carrier server 390, and communicate the estimated cost to the client computer.

As FIG. 5 illustrates, active container display 520 additionally includes a container sidebar 523 displayed alongside active container display 520. As FIG. 5 shows, container sidebar 523 displays information about active container display 520, such as information about the longest item, the heaviest item, and the item with the largest volume. This information may be useful, for example, in reallocating items to other containers associated with the order.

As FIG. 5 shows, active container display 520) includes a container pictorial representation 530 including non-textual elements that graphically depicts the associated shipping container. Container pictorial representation 530 may, for example, be sized to reflect the dimensions defined by the container parameter data associated with the corresponding order container record. As FIG. 5 shows, container pictorial representation 530 is substantially geometrically similar to the displayed dimensions of the associated type of shipping container. Contrasting container pictorial representation 530 to a pictorial representation 545 associated with inactive container display 535, one can see how the different containers' dimensions are reflected in the associated containers' pictorial representations.

In some examples, displaying the one or more dynamically updating container displays may include calculating combined item parameters and depicting a suggested container based on the combined item parameters.

The combined item parameters may be calculated by, for example, summing the parameter data of each unit of each order item associated with an order. As FIG. 3 illustrates, each ordered item is associated with item parameter data that indicates the weight capacity and dimensions required to properly pack the associated item. Using this parameter data and the ordered quantity of each item, the graphical fulfillment server can determine the amount of space and weight capacity required to ship all of the items associated with the order. In some examples, the container parameter data associated with one or more containers associated with an order may be adjusted to adjusted container parameters, if the container is not suitable for packing the combined item parameters. In some examples, pictorial displays of containers may be adjusted to reflect the adjusted container parameters.

Using the combined item parameters, the graphical fulfillment server may determine the one or more containers that would most efficiently fulfill the order. In some examples, the graphical fulfillment server may direct all of the ordered items to be packed in a single container. In other examples, however, the graphical fulfillment server may direct that it is more economical to divide the single order into multiple containers and or multiple shipments. In determining the appropriate distribution of items, graphical fulfillment server 300 may receive pricing data associated with one or more carriers and distribute the ordered items in the manner deemed most economical in light of the received pricing data.

In some examples, the combined item parameters may be used to determine a suggested container that defines the minimum size container to fit all of the items. For example, an order may consist of 3 6″ SCSI Cables. Based on the item parameter data associated with 6″ SCSI Cables, the graphical fulfillment server may, for example, determine that all three items may fit in a container 10 inches long, 6 inches wide, and 2 inches tall.

Alternatively, item parameters may be configured to determine which items may fit in a given container. For example, a container of 10 inches long, 6 inches wide, and 2 inches tall may be selected as the active container. The graphical fulfillment server may determine, with processor executable instructions, which item combinations may fit in the container. The graphical fulfillment server may do this, for example, based on combined item parameters associated with the ordered items and various combinations thereof. In some examples, the graphical fulfillment server may account for packing materials, unwieldy product shapes, or other criteria that may not be clearly represented in items' dimensions. In some examples, the graphical fulfillment server may consider various layouts and/or item organizations based on items' dimensions to determine how to maximize space within a container when packing the items. In some examples, graphical fulfillment interfaces may display depictions of such layouts or organizations.

In some examples, multiple orders associated with a single customer may be combined into a single order and displayed on the graphical fulfillment interface and/or associated with a single combined order record. The graphical fulfillment server may automatically detect that two pending orders are associated with the same customer and associate the order's ordered items with the single combined order automatically.

For example a single customer may have placed 2 orders at similar times, perhaps the same morning. Because they are both pending, it may be more efficient or economical to ship the items associated with both orders in a single package or otherwise combine the items associated with each order into common containers. Because the graphical fulfillment server detected this and allocated the items appropriately, the fulfillment staff will know to pack these items together. In some examples, however, the fulfillment staff may notice this before the graphical fulfillment server. In such cases, they may manually combine orders, such as with a combine order element 598 displayed in the graphical fulfillment interface.

In some examples, graphical fulfillment entries may display a textual depiction of the suggested container(s); for example, graphical fulfillment interface 501 may include a suggested container entry 570 depicting the suggested container. In some examples, container suggestions may include a container manufacturer and model. For example, FIGS. 5-8 display, associated with the suggested container, a manufacturer defining ABC Box Co. and a model defining 137. Additionally or alternatively, the suggested container(s) may be automatically added to the associated order record and displayed on the graphical fulfillment interface. As FIG. 5 shows, active container display 520 is set as the type of container suggested by the graphical fulfillment server.

In some examples suggesting multiple containers, the graphical fulfillment server may perform an item-by-item analysis that determines how to best to allocate ordered items to minimize unused space within containers associated with the order. In some examples, graphical fulfillment interfaces may display the results of this item-by-item analysis and the resulting item distribution. The fulfillment staff may review the analysis and resulting distribution to properly allocate the items between containers when packing.

In some examples, the inventories available at source locations and those locations' proximity to package destinations may be considered in determining suggested containers. For example, FIG. 5 may represent an order may be placed by a customer in San Diego, Calif., from a business with warehouses in Los Angeles, Calif., and Miami, Fla. At the time the order is placed, the Los Angeles, Calif. warehouse may not have sufficient 6″ SCSI Cables in stock, and only plans to restock the item in the distant future. The Miami, Fla., warehouse, however, may have a large quantity of 6″ SCSI Cables available. As a result, it may be more beneficial to send the remaining Ergo Keyboards from the Miami, Fla. location, despite the long distance. FIG. 5's display and distribution between active container display 520 and inactive container display 535 reflects this configuration, depicting the three 6″ SCSI Cables packed in a different container than the rest of the order.

In some examples, graphical fulfillment servers may check entities' overall inventories and determine if products are available at all. In some cases, some items may be completely out of stock, and orders may not be able to be immediately fulfilled as a result. Graphical fulfillment servers may, in these examples, suggest containers or delivery methods that provide prompt shipment of the available items while waiting for the other items to be restocked.

In some examples, displaying the graphical fulfillment interface may include displaying one or more user-selectable allocation adjustment controls. As FIG. 5 illustrates, each depiction of each item associated with the order includes an allocated item element 510 that is configured to allocate one unit of the associated item to active container display 520. In response to user-selection of one of the user-selectable allocation adjustment controls, the allocated quantity of the associated ordered item may be adjusted.

As FIG. 7 shows, some examples may include bulk allocation tools, such as an add all items element 551 and a single box selection element 550. By selecting add all items element 551, the graphical fulfillment server will determine a method of shipping that is deemed most economical and efficient to automatically allocate all of the ordered items to containers. In determining the most economical and efficient allocation, the previously described considerations, such as inventory, pricing, and delivery time may be considered. Implementing a computer to provide this service provides particular benefit, as fulfillment staffs may find it impractical or inefficient to receive up-to-date pricing and inventory information and properly calculate efficient item allocations in containers in response to this information.

By selecting single box selection element 550, a user may force the graphical fulfillment server to allocate all ordered items into a single container. As FIG. 7 illustrates, this may force the graphical fulfillment server to select a shipping method that may not necessarily be the most economical, but may be desirable for other reasons, such as packing expenses.

In some examples, graphical fulfillment servers automatically allocate ordered items to suggest or implement shipping methods. The ordered items may, for example, be allocated prior to displaying the graphical fulfillment interface, and the initially generated graphical fulfillment interface may reflect the automatically allocated items. Items may be allocated according to many principles described in this disclosure. For example, shipping methods and/or allocation may be based strictly on the most cost effective method of packing given a delivery time. In such examples, graphical fulfillment servers may ensure timely delivery of packages while concurrently ensuring that ordered items are allocated in the most efficient method possible given the restraint of a particular delivery deadline.

In some examples, suggested containers, suggested shipping methods, and carrier pricing may be displayed in a secondary layer that appears on the graphical fulfillment interface when a user selects a close container element. In some examples, the container dialog may overlay a portion of the graphical fulfillment interface. In some examples, the secondary layer may additionally or alternatively include a user-selectable print label element configured to print a shipping label associated with the container.

In some examples, displaying the graphical fulfillment interface includes displaying container controls, such as a select container element and a close container element. For example, FIG. 5 illustrates a select container element 571 associated with the displayed order. Select container element 571 is configured to display a dialog that allows a user to adjust the active container to an alternative container type selected from the graphical fulfillment server's container data. In some examples, the inventory data may include container inventories and the listed containers may be limited based on the containers that are in stock. In some examples, the user may have associated a carrier with the current order, and the containers from which the user may select may be limited to containers available from the associated carrier.

In some examples, displaying the graphical fulfillment interface includes displaying a close container element associated with each container that has not yet been closed. For example, FIG. 5 illustrates a close container element 572. A user may select the close container element to indicate that no more items should be allocated to the associated container prior to shipping. Upon the container being closed, the graphical fulfillment interface may provide a user with the option to print a shipping label to be used with the container.

In some examples, displaying the graphical fulfillment interface may include displaying a dynamically updating carrier selection element. For example, the interface shown in FIG. 5 includes a carrier selection element 575. The carrier selection element may be adjusted to associate a selected carrier with the current order.

In some examples, carriers may be associated with individual containers instead of whole orders. In such examples, additional or alternative carrier selection elements may be displayed to include a distinct carrier selection element for each container associated with the order.

In other examples, the carrier selection interface may include one or more estimated costs of shipping the associated container or order with each potential carrier. For example, carrier selection element 575, in FIG. 5, includes carrier cost displays 578 associated with each carrier. In some examples, these estimated costs may be based on pricing data retrieved from a carrier server, such as shipping carrier server 390.

In some examples, the carrier selection element may display multiple methods of shipping with the same carrier. For example, a carrier may be able to package ordered items in more than one particular multiple-container arrangement. In such examples, the carrier selection element may allow the user to select one particular method from the multiple displayed methods, and allocate ordered items to containers accordingly. In various examples, these methods may be determined based on cost of local item availabilities.

As FIG. 4 shows, allocation data is entered as items are packed into one or more containers at step 413. Graphical fulfillment interfaces allow staff to dynamically update allocation and fulfillment data as they fulfill customer orders. For example, fulfillment staff may select the allocate item element associated with a packed item after packing an ordered item. Because the graphical fulfillment interface updates dynamically in response to the entered data, the graphical fulfillment server provides a substantially real-time visual guide that fulfillment staff members may view in fulfilling customer orders.

FIG. 6, for example, illustrates an allocated item element 510 associated with each ordered item associated with a customer order. If, for example, a fulfillment staff member selects an allocated item element 510 associated with the Ergo Keyboard, one of the unallocated Ergo Keyboards would be allocated to the active container 520 displayed on FIG. 6. By allocating the unit of the ordered item to the active container, both the associated ordered item record's allocated quantity and the order container record's allocated items are updated to reflect the allocation of the unit of the ordered item to the active container.

In some examples, users may select from one of multiple open containers to select the container in which future items will be allocated. This may allow users to allocate different items to different containers during shipping. This may be particularly useful, for example, when a member of the fulfillment staff notices an unexpected inefficiency in an automatically generated order allocation scheme. In other examples, however, the active container remains active until being closed, and the fulfillment staff is only able to allocate items to the active container.

As FIG. 4 shows, the data on the graphical fulfillment server is updated at step 415. At this step, the data on the graphical fulfillment server is simply refreshed to reflect any data entered by fulfillment staff, changes in inventory, or data received from shipping carrier servers. In each of these cases, various updates may reflect other related data; for example, a change in inventory may, ultimately, affect the allocated quantity of a particular item. Similarly, a change in pricing data may change the container records associated with a particular order, as it may change the most economical and efficient manner in which ordered items should be packed.

As FIG. 4 shows, the dynamically updating elements of the graphical fulfillment interface are updated at step 420. In various examples, updating the dynamically updating elements may include adjusting one or more of the pictorial quantity graphics, adjusting one or more container overlays, adjusting one or more of the container pictorial graphics, and updating the carrier cost displays. Each of these elements are configured to be adjusted in response changes in the data stored on the graphical fulfillment server. In particular, several of the graphical fulfillment interface's dynamic elements are configured to provide fulfillment staff members with a substantially real-time visual guide depicting the current fulfillment status of an order.

In some examples, adjusting the dynamically updating elements of the graphical fulfillment interface includes adjusting one or more pictorial quantity graphic in response to a change in the allocated quantity of the associated item. As described above, graphical fulfillment servers are configured to calculate a fulfillment status associated with each item based on the item's ordered quantity and the quantity of the ordered item that has been allocated to one or more containers associated with the order. In response to the updated fulfillment status, the pictorial graphic updates to reflect the fulfillment status update.

For example, FIG. 8 illustrates an example wherein a user selected an allocated item element 510 associated with the 6″ SCSI Cables, thus allocating the final 6″ SCSI Cable to the active container 520. Because all of the ordered quantity has been allocated, the allocated quantity display 512 associated with the 6″ SCSI Cables is updated to indicate that all of the ordered quantity is presently allocated. For example, the background of the allocated quantity display 512 associated with the 6″ SCSI Cables may incorporate a green color. As FIG. 8 illustrates, the textual elements of the quantity display are updated dynamically along with the graphical elements, and the text associated with the 6″ SCSI Cable's quantity display is updated to reflect that 3 items have been allocated.

FIG. 6 illustrates a similar example, where the user selects to add the first of the Ergo Keyboards. In response, the allocated quantity display 512 associated with the Ergo Keyboards may incorporate an orange color to indicate that some, but not all, of the Ergo Keyboards have been allocated to one of the containers associated with the order.

In some examples, adjusting the dynamically updating elements of the graphical fulfillment interface includes adjusting one or more container overlays in response to adjustments to the ordered items allocated to each container. The container overlay may be adjusted, for example, in response to changes in the allocated quantities of ordered items.

Turning back to FIG. 8, wherein a user has selected to add the third and final 6″ SCSI Cable to active container 520, thereby adjusting the items allocated to the active container. As FIG. 8 shows, a container overlay 522 associated with active container 520 is updated to reflect this adjustment to the allocated items.

For example, the overlay includes an updated allocated items display 524, a container weight display 526, a used capacity display 527, and an estimated cost display 528 and other potentially displayed container data, such as container manufacturers, container models, and container images, that are each updated to reflect all of the items allocated to the container, including the item just added.

In addition to the overlay, other textual elements associated with active container 520 may also be adjusted in response to adjustments to allocating the items. For example, FIG. 5 illustrates a container sidebar 523 that includes data associated with the allocated items that may be updated if a newly allocated item is larger, heavier, and/or more voluminous than those items already allocated.

In some examples, adjusting the dynamically updating elements of the graphical fulfillment interface includes adjusting one or more container pictorial graphic associated with the order in response to a change in the type of container or another change to the container parameter data. In some examples, the parameter data associated with the active container may be adjusted manually by selecting a different container using select container element 571. For example, the container display may be adjusted to be geometrically similar to the dimensions defined by the container type selected through select container element 571.

In some examples, the graphical fulfillment server may suggest that the active container be resized, replaced, or supplemented with an additional container in response to the combined item parameters of the items allocated to the active container exceeding the active container's capacity. As previously discussed, each order item record includes item parameter data defining suggested dimensions and a suggested weight capacity associated with packing an individual unit of the ordered item, and each container record includes container parameter data denoting container dimensions and container weight capacity. When order items are allocated to the container, combined item parameters may be calculated based on the ordered quantity of the ordered item, the suggested dimensions associated with packing an individual unit of the ordered item, and the suggested weight capacity associated with packing an individual unit of the ordered item. If these combined item parameters exceed container dimensions, the container's parameter data may be adjusted or the active container may be resized, replaced, or supplemented.

The graphical fulfillment interface may display one or more containers determined to be suitable for efficiently packing the combined item parameters, including any resized, replaced, or supplemental containers deemed necessary based on the calculated combined parameter data and other disclosed considerations. In some examples, the initially displayed container or containers may reflect suitable pre-determined criteria for efficiently packing the ordered item, based on the calculated combined item parameters and other disclosed considerations.

In some examples, the graphical fulfillment interface may display a dialog requesting the user to select an additional or alternative container in response to the combined item parameters exceeding the active container's parameters. In some examples, the graphical fulfillment interface may automatically select an additional or alternative container in response to the combined item parameters exceeding the active container's parameters.

In some examples, adjusting the dynamically updating elements of the graphical fulfillment interface includes adjusting the shipping cost displayed in the carrier selection element. Allocating items to the containers associated with the order will often adjust the total shipping cost for the order. Additionally or alternatively, adding additional containers to the order may adjust the total shipping cost of the order. To provide the user with an up-to-date price associated with each carrier, the graphical fulfillment server may retrieve updated carrier shipping pricing data denoting shipping rates charged by a parcel carrier and update each estimated cost display based on allocated items' weights, containers' dimensions, containers' weight, and the received shipping rates, such as estimated cost displays 528 depicted in FIG. 5. In some examples, graphical fulfillment server may periodically poll shipping carrier servers and check for updated pricing data. The graphical fulfillment server may additionally or alternatively update estimated cost displays in response to detected changes in inventory data, including local inventory data.

One or more of the shipping containers is adjusted to a closed configuration in response to user selection at step 445. For example, FIG. 5 illustrates an example wherein each of the ordered items have been allocated to containers and a user may determine that he is prepared to ship the container, and no more items should be allocated to it. The user may select close container element 572 to indicate, on the graphical fulfillment server, that the container is closed and ready to be shipped.

FIG. 6 provides an example of a closed container, closed container 521. As FIG. 6 shows, containers may be closed prior to all of the ordered items associated with an order being allocated to a container. As FIG. 6 shows, closed container 521 shows that the container display has been adjusted to depict closed container 521 as “closed” in response to user selection of the close container control, as closed container is set as inactive and is clearly marked as closed. Closed containers may be depicted in additional or alternative ways, such as by adjusting pictorial representations of closed containers. Further, as FIG. 6 shows, a print label element, such as a print label element 580, may be displayed alongside closed containers. In some examples, closed containers may be deemed inactive by default. Additionally or alternatively, closed containers may be segregated from other containers to clearly indicate that they are closed and presently ready to ship.

As FIG. 3 shows, a shipping label is printed in response to user selection of a print label element at step 450. In printing the shipping label, the graphical fulfillment server may be instructed to contact the parcel carrier server corresponding to the carrier associated with the current order, and pay shipping costs associated with the associated container.

The printing label may, for example, indicate that the shipping fees have been paid to the carrier, at pickup, or otherwise indicate that the container is ready for shipment. Further, when the print label element is selected, the graphical fulfillment server may automatically contact the parcel carrier server to set up an appointment for the carrier to pick up the associated container.

Printing labels may be automatically generated using data received from shipping carrier servers and data stored on the graphical fulfillment server. For example, printing labels may reflect received shipping costs, stored customer information, and other relevant data. Printing labels may, for example, be printed by a printer in a shipping facility or other location accessible by the fulfillment staff.

As FIG. 3 shows, one or more containers associated with an order are shipped at step 455. In some examples, this may simply include handing a carrier a container at the appointed time with an appropriate label affixed.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A graphical logistics management method, comprising:
providing a data storage storing an order item record associated with an order, the order item record including an order quantity field including quantity data denoting an ordered quantity of an ordered item; and
displaying, on a display unit of a computer configured to access the order item record, a pictorial quantity graphic depicting an allocated quantity of the ordered item allocated to one or more shipping containers associated with the order.

2. The method of claim 1, further comprising adjusting the pictorial quantity graphic in response to the allocated quantity being adjusted.

3. The method of claim 2, further comprising:
displaying on the display unit a graphical user interface including an allocation adjustment control for adjusting the allocated quantity; and
adjusting the allocated quantity of the ordered item in response to a user requesting to adjust the allocated quantity with the allocation adjustment control.

4. The method of claim 3, wherein:
providing the data storage includes hosting the data storage on a network-accessible data server; and
further comprising transferring, over a computer network, browser executable code for displaying the graphical user interface on a client computer.

5. The method of claim 1, further comprising:
calculating a fulfillment status of the ordered quantity, including subtracting the allocated quantity from the ordered quantity; and
updating the pictorial quantity graphic to reflect a change in the fulfillment status.

6. The method of claim 5, wherein:
the one or more shipping containers associated with the order includes a plurality of shipping containers associated with the order; and
calculating the fulfillment status includes subtracting the allocated quantity of the ordered item allocated to each of the plurality of shipping containers associated with the order.

7. The method of claim 5, wherein updating the pictorial quantity graphic to reflect the change in the fulfillment status includes incorporating a fulfillment status color scheme into the pictorial quantity graphic, where the fulfillment status color scheme involves:
incorporating a first color to indicate that none of the ordered quantity is presently allocated;
incorporating a second color to indicate that at least one of the ordered quantity is presently allocated, but fewer than all of the ordered quantity is presently allocated; and
incorporating a third color to indicate that all of the ordered quantity is presently allocated.

8. The method of claim 1, wherein:
the data storage stores one or more additional order item records, each additional order item record including additional quantity data denoting an additional ordered quantity of an additional ordered item; and
further comprising displaying for each additional ordered item, on the display unit of the computer configured to access the order item record, a distinct additional pictorial quantity graphic associated with the additional ordered item, each additional pictorial quantity graphic representing an additional allocated quantity of the additional ordered item allocated to one or more shipping containers associated with the order.

9. The method of claim 8, further comprising:
displaying on the display unit a distinct additional allocation adjustment control associated with each of the additional ordered items; and
adjusting the additional allocated quantity of the additional ordered item when a user requests to adjust the additional allocated quantity with the allocation adjustment control.

10. The method of claim 1, wherein the order item record is associated with item parameter data defining suggested dimensions for packing an individual unit of the ordered item and a suggested weight capacity for packing the individual unit of the ordered item; further comprising:
calculating, with a processor, combined item parameters based on the ordered quantity, the suggested dimensions associated with packing an individual unit of the ordered item, and the suggested weight capacity associated with packing the individual unit of the ordered item; and
displaying, on the display unit, a container display depicting one or more suggested containers suitable for efficiently packing the combined item parameters.

11. A graphical logistics management method, comprising:
providing a data storage storing:
an order item record including an order quantity field including quantity data denoting an ordered quantity of an ordered item; and
an order container record associated with a shipping container for an order; and
displaying, on a display unit of a computer configured to access the order item record, a container display including a container pictorial representation depicting the shipping container, the container display configured to dynamically update to reflect the order container record.

12. The method of claim 11, further comprising:
displaying on the display unit a graphical user interface including an allocation adjustment control; and
adjusting an allocated quantity of the ordered item allocated to an active container in response to a user requesting to adjust the allocated quantity with the allocation adjustment control.

13. The method of claim 12, wherein the container display includes a container overlay depicting a used capacity and a container parameter display displaying parameter data associated with the container; and further comprising adjusting dynamically the container overlay in response to a change in the allocated quantity of the ordered item.

14. The method of claim 11, wherein:
the order container record is associated with parameter data denoting dimensions of the shipping container; and
displaying the container display includes displaying on the display unit a proportional container pictorial representation of the shipping container that is geometrically similar to the dimensions of the shipping container.

15. The method of claim 11, further comprising:
adding an additional container record associated with an additional shipping container for the order; and
displaying on the display unit an additional container pictorial representation depicting the additional shipping container.

16. The method of claim 11, further comprising:
displaying on the display unit a graphical user interface including a user-selectable close container control associated with the order container record; and
adjusting the container pictorial representation to depict a closed container in response to a user selecting the close container control.

17. The method of claim 11, wherein:
the order item record includes item parameter data defining suggested dimensions associated with packing an individual unit of the ordered item and a suggested weight capacity associated with packing an individual unit of the ordered item; and
the order container record includes container parameter data denoting container dimensions and container weight capacity; and further comprising:
calculating, with a processor, combined item parameters based on the ordered quantity of the ordered item, the suggested dimensions associated with packing an individual unit of the ordered item, and the suggested weight capacity associated with packing an individual unit of the ordered item;
adjusting the container parameter data to adjusted container parameters if the shipping container is not suitable for packing combined item parameters; and
adjusting the container display to reflect the adjusted container parameters.

18. The method of claim 11, wherein:
the order item record includes item parameter data defining suggested dimensions associated with packing an individual unit of the ordered item and a suggested weight capacity associated with packing an individual unit of the ordered item; and
the order container record includes container parameter data denoting container dimensions and container weight capacity; and further comprising:
calculating, with a processor, combined item parameters based on the ordered quantity of the ordered item, the suggested dimensions associated with packing an individual unit of the ordered item, and the suggested weight capacity associated with packing an individual unit of the ordered item;
adding an additional container record associated with an additional shipping container associated with the order in addition to the shipping container if the shipping container is not suitable for packing the combined item parameters; and
displaying on the display unit an additional container pictorial representation depicting the additional shipping container.

19. The method of claim 11, wherein:
the ordered item includes item parameter data denoting an item weight of the ordered item; and further comprising:
retrieving carrier shipping data denoting shipping rates charged by a shipping carrier; and
displaying on the display unit an estimated shipping cost, which is calculated based on the item weight.

20. The method of claim 19, further comprising printing a shipping label that incorporates the shipping data received from the shipping carrier, wherein the shipping label is automatically generated by a fulfillment server.

21. A graphical logistics management method, comprising:
providing a data storage storing:
an order item record including an order quantity field including quantity data denoting an ordered quantity of an ordered item; and
one or more order container record associated with one or more shipping containers associated with an order;
allocating, automatically, the ordered items to each of the one or more shipping containers associated with the order according to a shipping method received from and automatically generated by a fulfillment server; and
displaying, on a display unit of a computer configured to access the order item record, a container display for each of the one or more order container records associated with the order, each container display reflecting the allocation of the ordered items.
